(19) United States
(12) Patent Application Publication
(10) Pub. No.: US 2016/0282167 A1
(43) Pub. Date: Sep. 29, 2016

(54) SYSTEM AND METHOD OF OPERATOR INDICATION FOR FILLING REDUCTANT TANK

(71) Applicant: Caterpillar Inc., Peoria, IL (US)

(72) Inventors: Dustin I. Landwehr, Kewanee, IL (US); Jason W. Hudgens, Washington, IL (US)

(73) Assignee: Caterpillar Inc., Peoria, IL (US)

(21) Appl. No.: 15/176,945

(22) Filed: Jun. 8, 2016

(51) Int. Cl. G01F 23/22; B60K 37/02; F01N 3/02; F01N 11/00; F01N 3/20

(52) U.S. Cl. CPC G01F 23/22; F01N 11/00; F01N 3/2066; F01N 3/02; B60K 37/02

(57) ABSTRACT

A system and method to provide an operator indication for filling a reductant tank is provided. A first temperature sensor and a second temperature sensor receives a first signal and a second signal indicative of a coolant temperature and an ambient temperature associated with the reductant tank, respectively. Further, a controller determines a rate of change of temperature of the coolant based on the first signal and the second signal. The controller predicts thawing time for the fill valve based on the rate of change of the temperature of the coolant. The controller provides a first indication to the operator of a ready-to-fill status of the reductant tank based on the thawing time. The controller receives a third signal indicating a level of reductant in the reductant tank from a level sensor to identify a tank-full status of the reductant tank and to provide a second indication to the operator.

### TECHNICAL FIELD

The present disclosure relates to a pump electronic tank unit associated with a machine. More particularly, the present disclosure relates to a system and a method of an operator indication to fill a reductant tank of the pump electronic tank unit.

### BACKGROUND

An aftertreatment system is typically associated with an engine system to reduce undesired emissions from the engine system. During operation of the engine system, exhaust gas, which is generated, may include Nitrogen oxides (NOₓ) as well as other compounds. The aftertreatment system is configured to treat and reduce NOₓ and/or other compounds, prior to release of the exhaust gas into the atmosphere. In order to reduce NOₓ, the aftertreatment system may include a Selective Catalytic Reduction (SCR) module and a pump electronic tank unit (PETU). The PETU operates as a reductant delivery system that stores, controls, and supplies the reductant to the SCR module. The PETU may include a reductant tank with a fill valve. During a filling operation, a reductant supply source delivers the reductant to the reductant tank through the fill valve. The fill valve is disposed in the reductant tank and is structured to allow flow of the reductant into the reductant tank. The PETU supplies the reductant from the reductant tank to the SCR module. The SCR module uses the reductant to reduce the amount of NOₓ emissions in the stream of exhaust gases.

In heavy construction machines, such as excavators or shovels, the PETU is located at a distance above the ground. For example, the position of the PETU may be approximately 15-25 feet above the ground. In such machines, a ground-level filling system may allow an operator to perform the filling operation of the reductant tank from the ground level. The ground-level filling system uses a service arm equipped with a set of controls that initiate and terminate the filling operation. The ground-level filling system includes a hose, which receives the reductant from the reductant supply source and delivers the reductant to the fill valve of the reductant tank. In cold temperatures, the fill valve of the reductant tank may be blocked by frozen reductant, thereby blocking the entry of the reductant to the reductant tank.

Typically, the operator may refer to a timer and then initiate a filling operation in which reductant is supplied to fill the reductant tank. The operator may refer to the timer and manually calculate an approximate time required for thawing of the frozen fill valve. However, the thawing time for the fill valve may vary based on different external conditions, such as weather. With varying external conditions, it may be difficult for the operator at the ground level to accurately deduce a condition of the fill valve and determine if the fill valve has been thawed enough for the filling operation to begin without causing damage to the aftertreatment system. In some cases, when the operator unknowingly initiates the filling operation before sufficiently thawing the till valve, the reductant may spill onto a surrounding area, which may be undesirable.

U.S. Pat. No. 9,243,755 describes a notification method to alert a vehicle operator of various parameters based on an exhaust fluid level sensor of an exhaust fluid storage tank. The disclosed method includes the notification of a consumption rate of the exhaust fluid. In addition, the method includes the notification of an amount of fluid to be added to the exhaust fluid storage tank.

However, known solutions may not provide an accurate indication of the condition of the till valve to the operator in charge of conducting the fill operation for the reductant tank. Hence, there is a need to provide an indication system associated with the reductant tank.

### SUMMARY OF THE DISCLOSURE

Various aspects of the present disclosure describe an operator indication system, and a method to provide an indication to the operator for filling a reductant tank on a machine. The operator indication system is configured to implement the method disclosed herein for performing operator indication. The operator indication system includes a first temperature sensor, a second temperature sensor, a controller, and an indicator assembly. The first temperature sensor generates a first signal indicative of the temperature of the coolant associated with the reductant tank. The second temperature sensor generates a second signal indicative of an ambient temperature associated with the reductant tank. Further, the controller is communicably coupled to the first temperature sensor, the second temperature sensor, and the indicator assembly. The controller receives the first signal and the second signal to determine a rate of change of the temperature of the coolant. The controller further predicts a thawing time for a fill valve of the reductant tank based on the determined rate of change of the temperature of the coolant. Further, the controller provides a first indication of a ready-to-fill status of the reductant tank based on the predicted thawing time. The first indication of the ready-to-fill status of the reductant tank is transmitted through the indicator assembly. The controller receives a third signal indicating a level of a reductant in the reductant tank from a level sensor. The controller further identifies a tank-full status of the reductant tank based on the third signal to provide a second indication of the tank-full status of the reductant tank. The controller changes a status of the second indication based on a predetermined range of the level of the reductant in the reductant tank. The second indication of the tank-full status of the reductant tank is transmitted through the indicator assembly.

### BRIEF DESCRIPTION OF THE DRAWINGS

FIG. 1 is a perspective view of an exemplary machine that includes a service arm and a pump electronic tank unit (PETU), in accordance with the concepts of the present disclosure;

FIG. 2 is a block diagram of the service arm of the machine of FIG. 1, in accordance with the concepts of the present disclosure;

FIG. 3 is a schematic view of an operator indication system, in accordance with the concepts of the present disclosure; and

FIG. 4 is a flowchart of a method of operation of the indication system of FIG. 3, in accordance with the concepts of the present disclosure.

### DETAILED DESCRIPTION

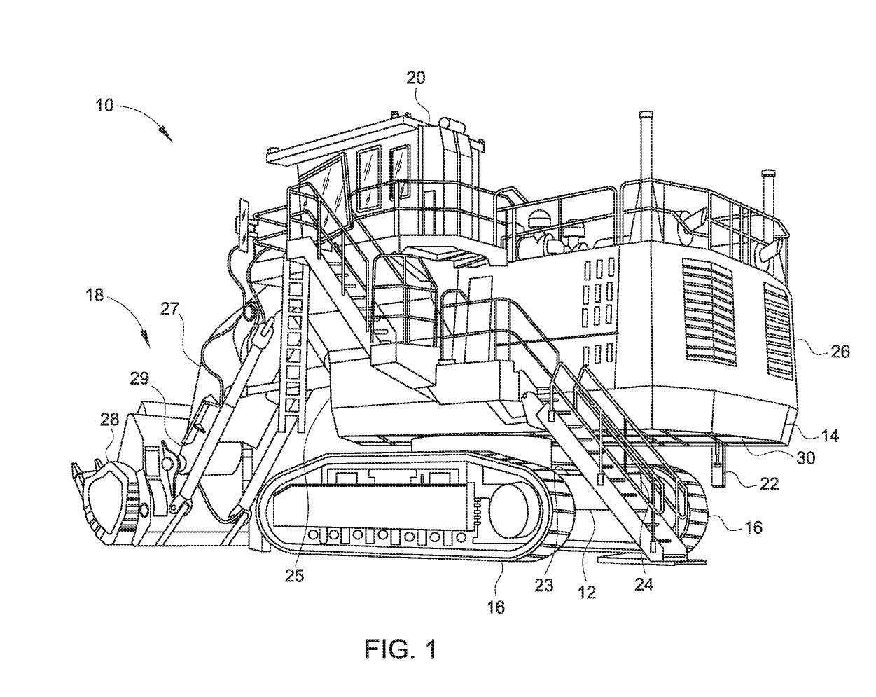

Referring to FIG. 1, an exemplary machine 10 incorporating the concepts of the present disclosure is shown. The machine 10 may embody heavy construction equipment, such as a hydraulic shovel (as shown in FIG. 1), an excavator, or a crane. The machine 10 includes a base 12, a frame 14, a pair of tracks 16 each of which is selectively and independently powered by an engine (not shown), an implement assembly 18, a cab 20, a service arm 22, and other parts of the machine 10.

The base 12 includes an upper surface 23 and multiple side surfaces 24. The upper surface 23 of the base 12 supports the frame 14 of the machine 10. The side surfaces 24 of the base 12 are connected to the tracks 16 that enable the movement of the machine 10.

The frame 14 includes a front side 25 and a rear side 26. The frame supports the implement assembly 18 and the cab 20 on the front side 25. The rear side 26 of the frame 14 supports the service arm 22 of the machine 10.

The implement assembly 18 of the machine 10 includes an arm 27 and an implement 28. A first end (not shown) of the arm 27 is pivotally connected with the front side 25 of the frame 14. The implement 28 is hingedly supported on a second end 29 of the arm 27. As shown in the illustrated embodiment of FIG. 1, the implement 28 is a bucket. However, in other embodiments, the implement 28 may include a grapple bucket, a blade ripper, a breaker, or an auger in lieu of the bucket disclosed herein.

The cab 20 is rigidly mounted on the frame 14. The cab 20 includes one or more operation control points (not shown) for operation of the machine 10. The operation control points (not shown) may regulate various operations of the machine 10, such as movement of the tracks 16 and the implement assembly 18.

The service arm 22 of the machine 0 is attached to a lower surface 30 of the frame 14 and located proximal to the rear side 26 of the frame 14. The service arm 22 will be discussed further in the description.

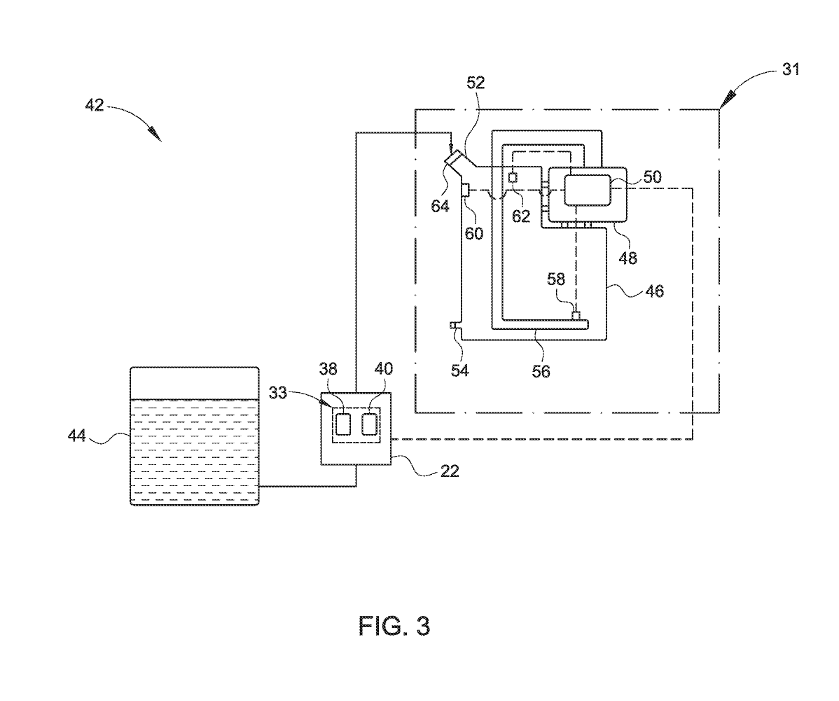

The engine may be an internal combustion engine, which may include a spark ignition engine, or a compression ignition engine. The engine includes an exhaust system, which is connected to an aftertreatment system. The aftertreatment system may include a Selective Catalytic Reduction (SCR) module and a Pump Electronic Tank Unit (PETU) 31 (refer to FIG. 3). The PETU 31 operates as a reductant delivery system, which stores, controls, and supplies the reductant to the SCR module for exhaust aftertreatment. The PETU 31 receives the reductant supply via the service arm 22.

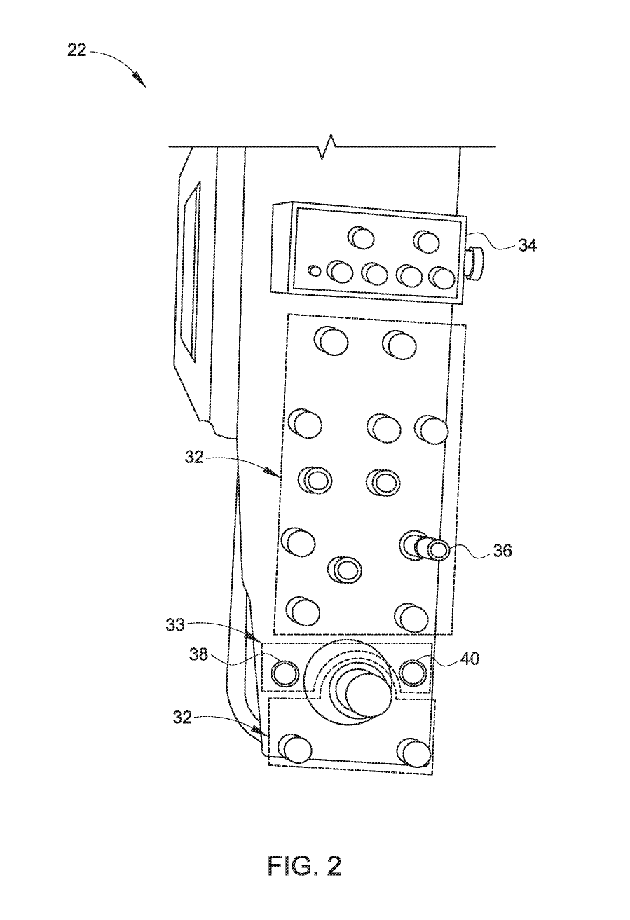

Referring to FIG. 2, the service arm 22 includes a set of operating fluid inlets 32, an indicator assembly 33, and a control panel 34. The set of operating fluid inlets 32 of the service arm 22 may include a fuel inlet, a gearbox oil inlet, a hydraulic oil inlet, a grease inlet, and the like. Each of the set of operating fluid inlets 32 is connected to a corresponding part of the machine 10 via an associated channel. The set of operating fluid inlets 32 includes a reductant inlet 36. The reductant inlet 36 is connected to the PETU 31 via a reductant channel (not shown) for filling reductant. The PETU 31 receives the supply of reductant through the reductant channel.

The indicator assembly 33 of the service arm 22 may generate an audio indication, a visual indication, an audio-visual indication, or a combination thereof. The indicator assembly 33 may be configured to indicate a status of a respective system of the machine 10. For example, the indicator assembly 33 may include a visual indicator (not shown) indicating the hydraulic oil level to an operator at the service arm 22. In one embodiment, the indicator assembly 33 includes a ready-to-fill indicator 38, and a full-tank indicator 40 associated with the PETU 31.

The operator may manually operate the control panel 34 of the service arm 22 to regulate the functions performed via the service arm 22. For example, filling of fluid via, each one of the set of operating fluid inlets 32 may be regulated by the operator using the control panel 34.

FIG. 3 shows an operator indication system 42, which includes the PETU 31, the service arm 22 with the indicator assembly 33, and an external reductant source 44. The PETU 31 is communicably connected to the external reductant source 44 and the service arm 22. The PETU 31 receives the reductant supply from the external reductant source 44 via the reductant inlet 36 (refer to FIG. 2) of the service arm 22.

The PETU 31 includes a reductant tank 46, a pump 48, an injector (not shown), and a controller 50. The reductant tank 46, the pump 48, the injector, and the controller 50 are communicably connected to each other. The PETU 31 introduces the reductant into the exhaust system (not shown) via the injector.

The reductant tank 46 includes a reductant filler neck 52, a drain outlet 54, a coolant channel 56, a first temperature sensor 58, a second temperature sensor 60, and a level sensor 62.

The reductant filler neck 52 is used to route or introduce reductant into the reductant tank 46. The reductant filler neck 52 includes a fill valve 64 that allows the flow of reductant into the reductant tank 46.

The drain outlet 54 of the reductant tank 46 is located in a lower portion of the reductant tank 46. The drain outlet 54 is fitted in the reductant tank 46 to drain the sludge from the reductant tank 46, and to correct an over filling event by allowing reductant fluid to egress the reductant tank 46.

The coolant channel 56 directs the flow of the coolant through the reductant tank 46 in order to prevent freezing of the reductant within the reductant tank 46. The pump 48 controls the flow of the coolant through the coolant channel 56.

The first temperature sensor 58 is communicably coupled to the coolant channel 56. The first temperature sensor 58 receives a first signal based on a temperature of the coolant flowing through the coolant channel 56 inside the reductant tank 46. The received first signal is transmitted by the first temperature sensor 58 to the controller 50 of the PETU 31.

The second temperature sensor 60 is disposed within the reductant tank 46. The second temperature sensor 60 is mounted in the proximity of the fill valve 64 in order to sense an ambient temperature inside the reductant tank 46. The second temperature sensor 60 receives a second signal based on the ambient temperature inside the reductant tank 46. The second temperature sensor 60 transmits the second signal to the controller 50 of the PETU 31. In one embodiment, the second temperature sensor 60 may be configured to sense the ambient temperature of the fill valve 64.

The level sensor 62 is disposed within the reductant tank 46, The level sensor 62 receives a third signal indicating a reductant level in the reductant tank 46. The level sensor 62 transmits the received third signal to the controller 50 of the PETU 31.

The controller 50 of the PETU 31 regulates the functions related to the pump 48, the injector (not shown), and the reductant tank 46. In a preferred embodiment, the controller 50 is an electronic control unit, However, in alternative embodiments, the controller 50 could be embodied in the form of an electrical control unit, a mechanical control unit, or a combination thereof.

The controller 50 may embody a single microprocessor or multiple microprocessors that include components for controlling operations of the PETU 31 based on inputs from the operator and/or based on sensed or other known operational parameters. Numerous commercially available microprocessors can be configured to perform the functions of the controller 50. It should be appreciated that the controller 50 could readily be embodied in a general machine microprocessor capable of controlling numerous machine functions. The controller 50 may include a memory, a secondary storage device, a processor, and any other components for running an application. Various other circuits may be associated with the controller 50 such as a power supply circuitry, a signal conditioning circuitry, a solenoid driver circuitry, and other types of circuitry. Various routines, algorithms, and/or programs can be programmed within the controller 50 for execution thereof to control operations of the PETU 31.

The controller 50 compares the received first signal indicating the coolant temperature with a predetermined coolant temperature value that is pre-stored in the controller 50. The predetermined temperature value for the coolant may include a single predetermined coolant temperature value, or a finite predetermined coolant temperature range having discrete values bound within an upper limit and a lower limit. When the coolant temperature indicated by the first signal reaches the predetermined coolant temperature value, the controller 50 determines a rate of change in the temperature of the coolant.

The rate of change in the temperature of the coolant is determined based on the received first signal indicating the coolant temperature and the second signal indicating the ambient temperature of the reductant tank 46. In one embodiment, the second signal can indicate the ambient temperature around the fill valve 64. The controller 50 interpolates the received values for the first signal and the second signal to determine the rate of change in the temperature of the coolant. As such, the rate of change in the temperature of the coolant may vary based on dynamically changing values of the ambient temperature and the coolant temperature.

The controller 50 predicts a thawing time for the fill valve 64 based on the rate of change in the temperature of the coolant. The thawing time for the fill valve 64 may vary based on the varying rate of change of temperature of the coolant. The thawing time for the fill valve 64 is determined based on a set of predetermined values for the rate of change of temperature of the coolant. The set of predetermined values for the rate of change of temperature of the coolant may include a graph based on a set of predetermined thawing times for the fill valve 64 with respect to a predetermined set of different values of the rate of change of the temperature of the coolant. In one embodiment, the controller 50 may determine in real time the thawing time or adjust the thawing time based on the first signal and the second signal.

The controller 50 provides a first indication of a ready-to-fill status of the reductant tank 46 upon completion of the predicted thawing time. The controller 50 transmits the first indication to the ready-to-fill indicator 38 of the indicator assembly 33. The ready-to-fill indicator 38 indicates the operator of the ready-to-fill status.

The controller 50 compares the received third signal with a predetermined value indicating a tank-full status of the reductant tank 46. The predetermined value indicating the tank-full status of the reductant tank 46 may include a single predetermined reductant level value, or a finite predetermined range for the reductant level having discrete values bound within upper and lower limits. The controller 50 identifies the tank-full status of the reductant tank 46 when the reductant level in the reductant tank 46 is equal to the predetermined value for the tank-full status.

The controller 50 provides a second indication of the tank-full status of the reductant tank 46 via the full-tank indicator 40 of the indicator assembly 33. in embodiments herein, the controller 50 is also configured to initiate a change in the status of any one of the first indication or the second indication if the level of the reductant in the reductant tank 46 lies in the predetermined range of values. The change of status of any one of the first indication or the second indication may include a change in visual appearance, a change in audio signal, or a combination of the two.

### INDUSTRIAL APPLICABILITY

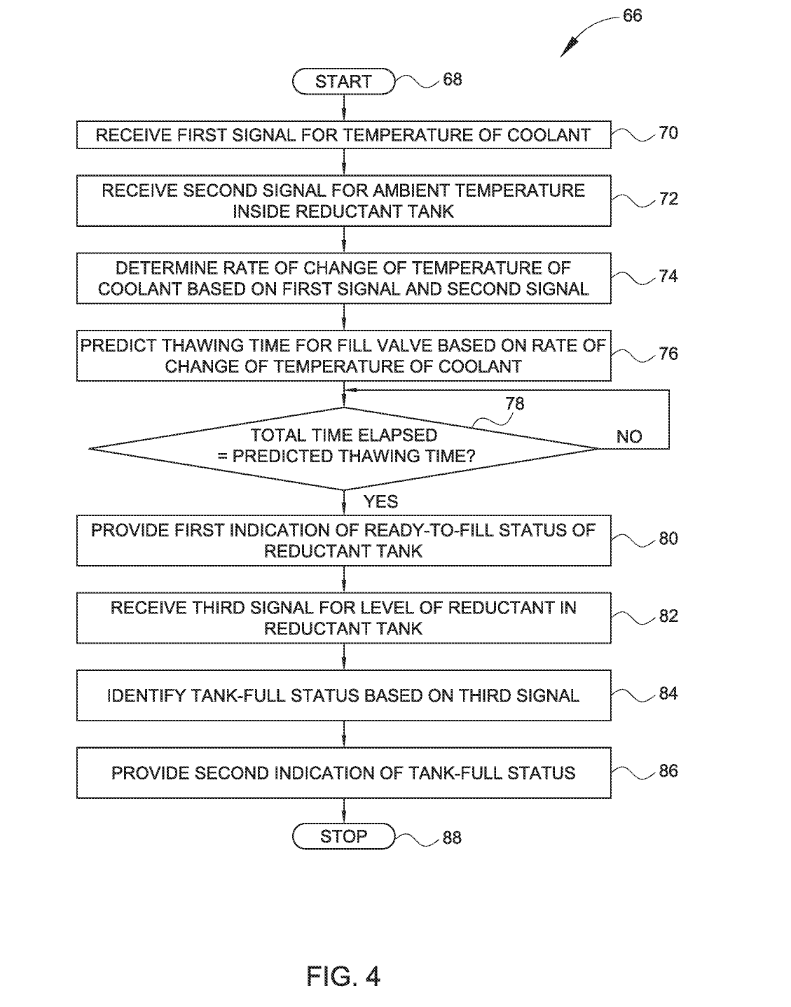

In operation, the disclosed operator indication system 42 provides the indication to the operator positioned outside the machine 10 about the ready-to-fill status and the tank-full status of the reductant tank 46. Referring to FIG. 4 in conjunction with elements of FIG. 3, a flow chart for a method 66 to indicate the operator for filling the reductant tank 46 of the machine 10 is described. The method 66 starts with step 68 by initiating the power of the machine 10 and proceeds to step 70.

In step 70, the controller 50 of the operator indication system 42 receives the first signal from the first temperature sensor 58. The received first signal indicates the temperature of the coolant flowing through the coolant channel 56 inside the reductant tank 46. The controller 50 compares the received first signal with the predetermined coolant temperature value. In an exemplary embodiment, the predetermined temperature value for the coolant may be equal to 80° C. However, in other embodiments, the predetermined temperature value may vary from one application to another depending on specific requirements of an application. For example, the predetermined temperature value may be set to 85 deg. C., 90 deg C., and the like.

As the coolant temperature indicated by the first signal reaches the predetermined coolant temperature value, the method 66 moves to step 72. In step 72, the controller 50 receives the second signal from the second temperature sensor 60. The received second signal indicates the ambient temperature of the reductant tank 46.

In step 74 of the method 66, the controller 50 determines the rate of change in the temperature of the coolant. The controller 50 interpolates values obtained from the first signal and the second signal to determine the rate of change of temperature of the coolant. The rate of change in the temperature of the coolant may change based on the dynamically varying values of the ambient temperature and the coolant temperature.

In step 76, the controller 50 predicts the thawing time for the fill valve 64. To predict the thawing time, the controller 50 compares the rate of change of temperature of the coolant with each value of the set of predetermined values for the rate of change of temperature of the coolant. The graph based on the set of predetermined values for the rate of change of temperature of the coolant is pre-stored in the controller 50. The graph includes the corresponding thawing time for each value of the rate of change of temperature of the coolant.

In step 78, the controller 50 determines a total time elapsed since initiating the power of the machine 10. The controller 50 compares the total time with the predicted thawing time for the fill valve 64. The method 66 proceeds to step 80 when the total time is equal to the predicted thawing time.

In step 80, the controller 50 provides the first indication of the ready-to-fill status of the reductant tank 46. The controller 50 provides the first indication when the total time elapsed since initiating the power of the machine 10 reaches the predicted thawing time. The first indication of the ready-to-fill status is provided to the operator through the ready-to-fill indicator 38.

Further, in step 82 of the method 66, the controller 50 receives the third signal from the level sensor 62. The third signal indicates to the controller 50, the level of the reductant in the reductant tank 46.

In step 84 of the method 66, the controller 50 identifies the tank-full status of the reductant tank 46 by comparing the received third signal with the predetermined value indicating the tank-full status of the reductant tank 46. The controller 50 identifies the tank-full status of the reductant tank 46 when the third signal approaches the predetermined value indicating the tank-full status.

On identification of the tank-full status of the reductant tank 46, the method 66 proceeds to step 86. In step 86, the controller 50 provides the second indication of the tank-full status of the reductant tank 46. The second indication of the tank-full status of the reductant tank 46 is provided to the operator via the full-tank indicator 40 of the indicator assembly 33.

The disclosed method 66 for the operator indication and the operator indication system 42 provides the first indication for the ready-to-fill status of the reductant tank 46 by accurately predicting the thawing time for the fill valve 64. The first indication to the operator for the ready-to-fill status of the reductant tank 46 improves the filling operation of the reductant in a ground-level filling system. Further, the second indication to the operator helps the operator to terminate the filling operation when the reductant level in the reductant tank 46 reaches a predefined or maximum capacity of the reductant tank 46. The second indication to the operator may thus help prevent the operator from overfilling the reductant tank 46.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claim(s) and any equivalents thereof.

What is claimed is:

1. A method of operator indication for filling a reductant tank on a machine, the machine including a service arm assembly and the reductant tank having a fill valve, the method comprising:
receiving a first signal indicative of a temperature of a coolant associated e reductant tank;
receiving a second signal indicative of an ambient temperature associated with the reductant tank;
determining a rate of change of the temperature of the coolant based, at least in part, on the received first and second signals;
predicting a thawing time for the fill valve based, at least in part, on the determined rate of change of the temperature of the coolant; and
providing a first indication of a ready-to-fill status of the reductant tank based on approaching the predicted thawing time, wherein the first indication is provided through an indicator assembly positioned on the service arm assembly of the machine.

2. The method of claim 1 further including:
receiving a third signal indicative of a level of a reductant in the reductant tank;
identifying a tank-full status of the reductant tank based on the third signal; and
providing a second indication of the tank-full status of the reductant tank via the indicator assembly based on the identification of the tank-full status of the reductant tank.

3. The method of claim 2 further comprising:
changing a status of at least one of the first indication and the second indication if the level of the reductant in the reductant tank lies in a predetermined range.

4. An indication system for a reductant tank on a machine, the indication system comprising:
a first temperature sensor configured to generate a first signal indicative of a temperature of a coolant associated with the reductant tank;
a second temperature sensor configured to generate a second signal indicative of an ambient temperature associated with the reductant tank;
an indicator assembly positioned on a service arm assembly of the machine; and
a controller communicably coupled to the first temperature sensor, the second temperature sensor and the indicator assembly, the controller configured to:
receive the first signal indicative of the temperature of the fluid associated with the fill valve;
receive the second signal indicative of the ambient temperature associated with the reductant tank;
determine a rate of change of the temperature of the coolant based, at least in part, on the received first and second signals;
predict a thawing time for the fill valve based, at least in part, on the determined rate of change of the temperature of the coolant; and
provide a first indication of a ready-to-fill status of the reductant tank based on approaching the predicted thawing time, wherein the first indication is provided through the indicator assembly.

5. The system of claim 4, wherein the controller is communicably coupled to a level sensor associated with the reductant tank, the controller configured to:
receive a third signal indicative of a level of a reductant in the reductant tank from the level sensor;
identify a tank-full status of the reductant tank based on the third signal; and
provide a second indication of the tank-full status of the reductant tank via the indicator assembly based on the identification of the tank-full status of the reductant tank.

6. The system of claim 5, wherein the controller is configured to:
change a status of at least one of the first indication and the second indication if the level of the reductant in the reductant tank lies in a predetermined range.
